(19) United States
(12) Patent Application Publication
(10) Pub. No.: US 2026/0302582 A1
(43) Pub. Date: Oct. 1, 2026

(54) Cavity Filter and Communication Device

(71) Applicant: Telefonaktiebolaget LM Ericsson (publ), Stockholm (SE)

(72) Inventors: Yuhua Xiao, Beijing (CN); Yulei Lin, Beijing (CN); Juandi Song, Beijing (CN)

(21) Appl. No.: 19/489,099

(22) PCT Filed: Jun. 12, 2023
(86) PCT No.: PCT/CN2023/099613

§ 371 Date: Dec. 1, 2025

(51) Int. Cl. H01P 1/205

(52) U.S. Cl. CPC H01P 1/2053; H01P 1/2056

(57) ABSTRACT

The present invention relates to a cavity filter and a communication device. The cavity filter according to an embodiment comprises a chassis (11; 21; 31) that defines a cavity having a top opening, at least one resonator (13; 23A-23D; 33A-33H) disposed in the cavity, and a cover plate (12; 22; 32) that covers the top opening of the cavity, wherein the cover plate (12; 22; 32) is made of a dielectric material, and a bottom surface of the cover plate (12; 22; 32) is provided with a metalized area (121; 221A-221D; 321A-321H) at a region corresponding to the resonator (13; 23A-23D; 33A-33H).

### TECHNICAL FIELD

The present disclosure generally relates to components of communication device, and more particularly, to a cavity filter and a communication device having the cavity filter.

### BACKGROUND

This section introduces aspects that may facilitate better understanding of the present disclosure. Accordingly, the statements of this section are to be read in this light and are not to be understood as admissions about what is in the prior art or what is not in the prior art.

Base station (BS) is an important part of a mobile communication system, and may include a radio unit (RU) and an antenna unit (AU). Considering the installation/fixation/occupation, smaller volume and lighter weight is always an important evolution direction in BS design, including legacy base station, street macro, micro, small cell and advanced antenna system (AAS).

With the development of 5th Generation (5G) communication, Multiple-Input and Multiple-Output (MIMO) technology is widely used in Sub-6 GHZ BS product, in which large amounts of filter units (FUs) need to be integrated with AU or RU. There are many kinds of filter solutions that can be applied to BS, such as ceramic waveguide (CWG) filters, coaxial metal cavity filters, Monoblock filters, bulk acoustic wave (BAW) filters, surface acoustic wave (SAW) filters, etc.

CWG FUs are easy to be soldered onto radio mother board (MOB), low pass filter (LPF) board, antenna calibration (AC) board or power splitter board, which will reduce the radio size and weight. However, there is much limitation of CWG FUs. The first is size limitation due to reliability issue: a CWG filter with big size is easy to crack when being soldered on a board, so if more poles are needed to realize better out of band attenuation, there will be much design limitation due to ceramic size. The second is loss limitation: a CWG filter is often soldered with a printed circuit board (PCB) LPF to suppress remote harmonics, but a strip line PCB LPF always has big loss compared with a metal LPF, and a microstrip line PCB LPF will bring extra coupling from one batch to another.

Due to the insufficient reliability and loss limitation of CWG filters, metal cavity filters are widely used, which generally consists of a metal cavity and a plurality of resonators in the metal cavity. However, screw tuning of such metal cavity filters is complex, and it is hard to realize fully automated tuning when the filter size is small. The metal cavity filter is hard to achieve smaller size compared with CWG filters.

Therefore, it is important to find a new type of filter with good performance, small size and good reliability.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

One of the objects of the disclosure is to provide a cavity filter which has both pros of CWG filters and metal filters.

According to a first aspect of the disclosure, there is provided a cavity filter, comprising a chassis that defines a cavity having a top opening, at least one resonator disposed in the cavity, and a cover plate that covers the top opening of the cavity, wherein the cover plate is substantially made of a dielectric material, and a bottom surface of the cover plate is provided with a metalized area at a region corresponding to the resonator.

In an embodiment of the disclosure, the metalized area is formed by plating or printing on the bottom surface of the cover plate.

In an embodiment of the disclosure, the metalized area is formed by removing a part of a metalized layer on the bottom surface of the cover plate.

In an embodiment of the disclosure, a dielectric constant of the dielectric material and/or a size of the metalized area is associated with a desired frequency of the cavity filter.

In an embodiment of the disclosure, the dielectric material has a uniform dielectric constant throughout the cover plate.

In an embodiment of the disclosure, the dielectric material has different dielectric constants at different regions of the cover plate.

In an embodiment of the disclosure, a first dielectric constant of the dielectric material at a first region near the resonator is larger than a second dielectric constant of the dielectric material at a second region remote from the resonator.

In an embodiment of the disclosure, a top surface and a side surface of the cover plate are substantially entirely metalized.

In an embodiment of the disclosure, a frequency tuning blind hole is provided on the top surface of the cover plate at a position corresponding to the resonator.

In an embodiment of the disclosure, two or more resonators are disposed in the cavity, and a capacitance coupling or an inductive coupling between two adjacent resonators is achieved by setting a gap between two metalized areas on the bottom surface of the cover plate that correspond to the two adjacent resonators.

In an embodiment of the disclosure, a coupling tuning blind hole is provided on the top surface of the cover plate at a position corresponding to the gap.

In an embodiment of the disclosure, the dielectric material is ceramic or plastic.

In an embodiment of the disclosure, the chassis is made of metal or a non-metal base with a metallized surface.

In an embodiment of the disclosure, the at least one resonator is made of metal or a non-metal base with a metallized surface.

In an embodiment of the disclosure, the at least one resonator is integrally formed with the chassis.

In an embodiment of the disclosure, the at least one resonator is separately formed with and soldered to the chassis.

In an embodiment of the disclosure, the cover plate is joined to the chassis by soldering or screwing.

According to a second aspect of the disclosure, there is provided a communication device, which comprises at least one cavity filter according to the first aspect.

In an embodiment of the disclosure, the cavity filter is soldered on a radio board or an antenna board, or is connected to the radio board or the antenna board by an RF connector.

In an embodiment of the disclosure, the communication device is an AAS.

According to the present disclosure, the cover plate of the cavity filter is substantially made of a dielectric material, and a bottom surface of the cover plate is provided with a metalized area at a region corresponding to the resonator disposed in the cavity. Therefore, the cavity filter has good Q value and low insertion loss as compared with same size metal filters. On the other hand, the cavity filter has good harmonic performance, which is similar as metal filters and much better than CWG filters. Moreover, the cavity filter can be easily tuned at the top side of the cover plate, and no tuning screw is needed, so that the filter size can be reduced and automatic tuning can be achieved. Furthermore, by changing the dielectric constant of the dielectric material of the top plate, the cavity filter can have the same size for different frequency bands, which facilitates packaging of the cavity filter.

### BRIEF DESCRIPTION OF THE DRAWINGS

These and other objects, features and advantages of the disclosure will become apparent from the following detailed description of illustrative embodiments thereof, which are to be read in connection with the accompanying drawings, in which

FIGS. 1A-1C show a cavity filter according to a first embodiment of the disclosure;

FIG. 2A and FIG. 2B show a cavity filter according to a second embodiment of the disclosure;

FIG. 2C and FIG. 2D respectively show a top view and a bottom view of a cover plate of the cavity filter shown in FIGS. 2A and 2B;

FIG. 3 is a schematic diagram illustrating a topology of the cavity filter according to the second embodiment;

FIG. 4A and FIG. 4B each show a simulation frequency response curve of the cavity filter according to the second embodiment;

FIG. 5A and FIG. 5B show a cavity filter according to a third embodiment of the disclosure;

FIG. 5C and FIG. 5D respectively show a top view and a bottom view of a cover plate of the cavity filter shown in FIGS. 5A and 5B;

FIG. 6 is a schematic diagram illustrating a topology of the cavity filter according to the third embodiment;

FIGS. 7A-7H show different variants of a metalized area in a bottom surface of a cover plate of a cavity filter according to an embodiment of the disclosure;

FIGS. 8A-8E show different variants of a negative coupling structure in a bottom surface of a cover plate of a cavity filter according to an embodiment of the disclosure; and

FIGS. 9A-9G show different variants of a resonator in a cavity filter according to an embodiment of the disclosure.

### DETAILED DESCRIPTION

The embodiments of the present disclosure are described in detail with reference to the accompanying drawings. It should be understood that these embodiments are discussed only for the purpose of enabling those skilled in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. Those skilled in the relevant art will recognize that the disclosure may be practiced without one or more of the specific features or advantages of a particular embodiment. In other instances, additional features and advantages may be recognized in certain embodiments that may not be present in all embodiments of the disclosure.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

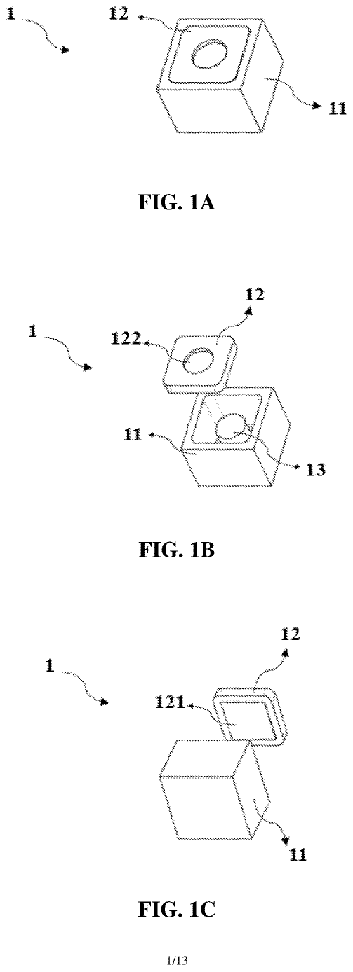

FIGS. 1A-1C show a cavity filter 1 according to a first embodiment of the disclosure, wherein FIG. 1A illustrates an assembled status of the cavity filter 1, and FIG. 1B and FIG. 1C each illustrate an exploded view of the cavity filter 1 seen from different directions.

The cavity filter 1 shown in FIG. 1A generally has the shape of a parallelepipedon, and includes a chassis 11 and a cover plate 12. The chassis 11 defines a cavity having a top opening. The cover plate 12 covers the top opening of the cavity. The cover plate 12 is joined to the chassis 11, for example, by soldering or screwing. As shown in FIG. 1A and FIG. 1B, a side surface of the cover plate 12 is joined to an inner surface of the chassis 11. Alternatively, a bottom surface of the cover plate 12 may be joined to an upper edge of the chassis 11. The cavity filter 1 further includes a resonator 13 disposed in the cavity.

The chassis 11 may be made of metal or a non-metal base with a metallized surface. For the case of a non-metal base with a metallized surface, at least the inner surface of the chassis 11 is entirely metallized, and the outer surface of the chassis 11 may be or may not be metalized. The resonator 13 may also be made of metal or a non-metal base with a metallized surface. The resonator 13 may be integrally formed with the chassis 11. Alternatively, the resonator 13 may be separately formed with and soldered to the chassis 11. The material of the resonator 13 may be the same as or different from the material of the chassis 11.

The cover plate 12 is substantially made of a dielectric material. For example, the dielectric material may be ceramic or plastic. A dielectric constant of the dielectric material is associated with a desired frequency of the cavity filter 1. The dielectric material may have a uniform dielectric constant throughout the cover plate 12. Alternatively, the dielectric material may have different dielectric constants at different regions of the cover plate 12; for example, a first dielectric constant of the dielectric material at a first region near the resonator 13 may be larger than a second dielectric constant of the dielectric material at a second region remote from the resonator 13.

In this embodiment, a top surface and a side surface of the cover plate 12 are substantially entirely metalized. On the other hand, a bottom surface of the cover plate 12 is only partially metalized. More specifically, the cover plate 12 is provided with a metalized area 121 at a region corresponding to the resonator 13.

The metalized area 121 may be provided by any known methods. For example, the metalized area 121 may be formed by plating or printing on the bottom surface of the cover plate 12. Alternatively, the bottom surface of the cover plate 12 may be initially entirely metalized to form a metalized layer like the top surface and the side surface of the cover plate 12, and then a part of the metalized layer on the bottom surface of the cover plate 12 may be removed by applying laser, for example, to form the metalized area 121. A size of the metalized area 121 is associated with the desired frequency of the cavity filter 1.

In this embodiment, a frequency tuning blind hole 122 is provided on the top surface of the cover plate 12 at a position corresponding to the resonator 13. The frequency tuning blind hole 122 may have a circular cross section as shown, or may be in the shape of a rectangle, an ellipse, or any other appropriate shapes in the cross section. The depth and the area of the frequency tuning blind hole 122 is associated with the desired frequency of the cavity filter 1. The bottom surface and the wall surface of the frequency tuning blind hole 122 are initially entirely metalized, and then a part of the metalized layer of the frequency tuning blind hole 122 may be removed by applying laser, for example, to tune the frequency of the resonator 13.

The cavity filter 1 in this embodiment has a size of 8 mm*8 mm*6.5 mm. The performance of the cavity filter 1 is shown in Table 1.

TABLE 1
The performance of the cavity filter 1

| | | |
|---|---|---|
| Mode | Frequency | Q value |

| | | | |
|---|---|---|---|
| Mode1 | 2.77 | GHz | 2072 |
| Mode2 | 8.31 | GHz | 787 |
| Mode3 | 8.36 | GHz | 791 |
| Mode4 | 12.04 | GHz | 790 |
| Mode5 | 12.12 | GHz | 892 |

As can be seen from Table 1, the second resonant frequency (8.31 GHz at Mode2) is about triple of the main resonant frequency (2.77 GHz at Mode1). Thus, the harmonic performance of the cavity filter 1 is similar as a metal filter and is better than a CWG filter. Moreover, the cavity filter 1 has good Q value and insertion loss compared with same size metal filter.

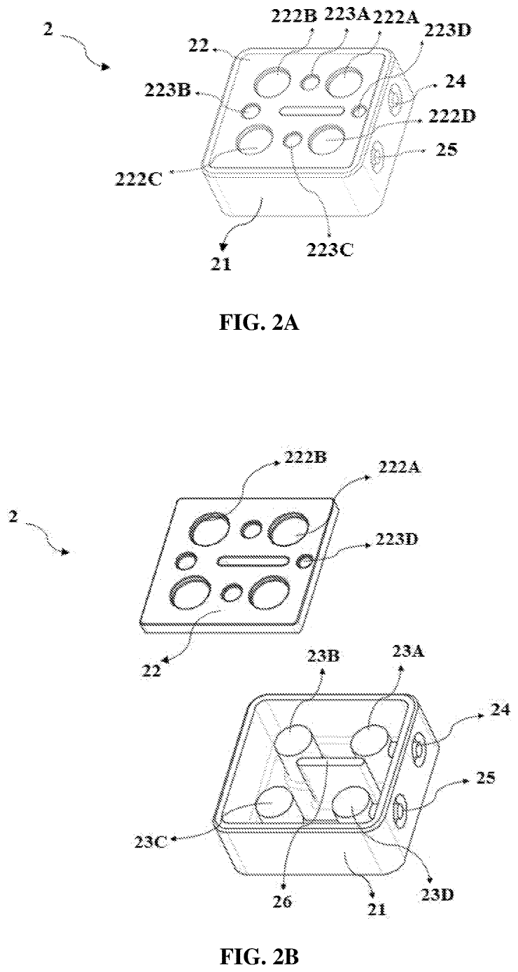

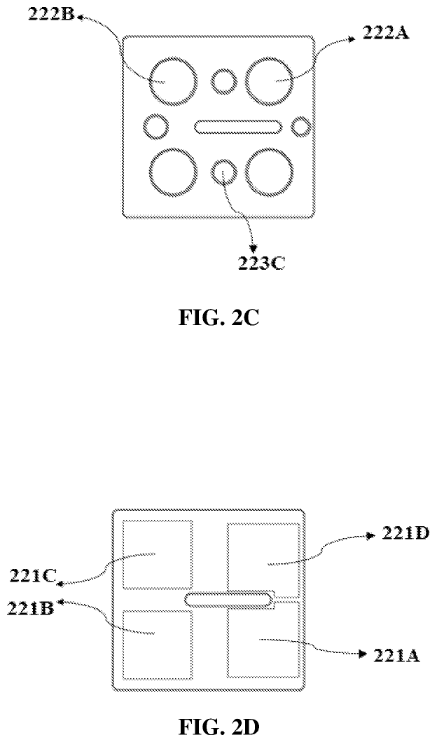

FIG. 2A and FIG. 2B show a cavity filter 2 according to a second embodiment of the disclosure, wherein FIG. 2A illustrates an assembled status of the cavity filter 2, and FIG. 2B illustrates an exploded view of the cavity filter 2. FIG. 2C and FIG. 2D respectively show a top view and a bottom view of a cover plate of the cavity filter 2.

The cavity filter 2 shown in FIG. 2A generally has the shape of a parallelepipedon, and includes a chassis 21 and a cover plate 22. The chassis 21 defines a cavity having a top opening. The cover plate 22 covers the top opening of the cavity. The cover plate 22 is joined to the chassis 21, for example, by soldering or screwing. As shown in FIG. 2A and FIG. 2B, a side surface of the cover plate 22 is joined to an inner surface of the chassis 21. Alternatively, a bottom surface of the cover plate 22 may be joined to an upper edge of the chassis 21. The cavity filter 2 further includes four resonators 23A-23D disposed in the cavity.

The chassis 21 may be made of metal or a non-metal base with a metallized surface. For the case of a non-metal base with a metallized surface, at least the inner surface of the chassis 21 is entirely metallized, and the outer surface of the chassis 21 may be or may not be metalized. The resonators 23A-23D may also be made of metal or a non-metal base with a metallized surface. The resonators 23A-23D may be integrally formed with the chassis 21. Alternatively, the resonators 23A-23D may be separately formed with and soldered to the chassis 21. The material of the resonators 23A-23D may be the same as or different from the material of the chassis 21.

The cover plate 22 is substantially made of a dielectric material. For example, the dielectric material may be ceramic or plastic. A dielectric constant of the dielectric material is associated with a desired frequency of the cavity filter 2. The dielectric material may have a uniform dielectric constant throughout the cover plate 22. Alternatively, the dielectric material may have different dielectric constants at different regions of the cover plate 22; for example, a first dielectric constant of the dielectric material at a first region near the resonators 23A-23D may be larger than a second dielectric constant of the dielectric material at a second region remote from the resonators 23A-23D.

In this embodiment, a top surface and a side surface of the cover plate 22 are substantially entirely metalized. On the other hand, a bottom surface of the cover plate 22 is only partially metalized. More specifically, the cover plate 22 is provided with four metalized areas 221A-221D at regions corresponding to the resonators 23A-23D.

The metalized areas 221A-221D may be provided by any known methods. For example, the metalized areas 221A-221D may be formed by plating or printing on the bottom surface of the cover plate 22. Alternatively, the bottom surface of the cover plate 22 may be initially entirely metalized to form a metalized layer like the top surface and the side surface of the cover plate 22, and then a part of the metalized layer on the bottom surface of the cover plate 22 may be removed by applying laser, for example, to form the metalized areas 221A-221D. A size of each of the metalized areas 221A-221D is associated with the desired frequency of the cavity filter 2.

In this embodiment, four frequency tuning blind holes 222A-222D are provided on the top surface of the cover plate 22 at positions corresponding to the resonators 23A-23D. Each of the frequency tuning blind holes 222A-222D may have a circular cross section as shown, or may be in the shape of a rectangle, an ellipse, or any other appropriate shapes in the cross section. The depth and the area of the frequency tuning blind holes 222A-222D is associated with the desired frequency of the cavity filter 2. The bottom surface and the wall surface of the frequency tuning blind holes 222A-222D are initially entirely metalized, and then a part of the metalized layer of the frequency tuning blind holes 222A-222D may be removed by applying laser, for example, to tune the frequency of the corresponding one of the resonators 23A-23D.

In this embodiment, a capacitance coupling (negative coupling) or an inductive coupling (positive coupling) between two adjacent resonators 23A-23D may be achieved by setting a gap between two metalized areas 221A-221D on the bottom surface of the cover plate 22 that correspond to the two adjacent resonators 23A-23D. More specifically, a capacitance coupling can be achieved when the distance between two adjacent metalized areas 221A-221D is small. As the distance between two adjacent metalized areas 221A-221D becomes larger, the coupling between the two corresponding resonators 23A-23D may change to an inductive coupling.

Further, four coupling tuning blind holes 223A-223D are provided on the top surface of the cover plate 22 at positions corresponding to the gaps between the adjacent metalized areas 221A-221D. Each of the coupling tuning blind holes 223A-223D may have a circular cross section as shown, or may be in the shape of a rectangle, an ellipse, or any other appropriate shapes in the cross section. The depth and the area of the coupling tuning blind holes 223A-223D is associated with the coupling of the corresponding adjacent resonators 23A-23D. The bottom surface and the wall surface of the coupling tuning blind holes 223A-223D are initially entirely metalized, and then a part of the metalized layer of the coupling tuning blind holes 223A-223D may be removed by applying laser, for example, to tune the coupling of the adjacent resonators 23A-23D.

As shown in FIG. 2A and FIG. 2B, the cavity filter 2 is provided with two RF ports 24, 25 on the same side of the chassis 21. The resonator 23A is connected to a first RF port 24, and the resonator 23D is connected to a second RF port 25. The location of the two RF ports 34, 35 can be adjusted according to actual requirements. For example, the two RF ports 34, 35 may be provided on two different sides of the chassis 31, or the two RF ports 34, 35 may be provided on the bottom of the chassis 31. The cavity filter 3 may be connected to a radio board or an antenna board through RF connectors, such as 50Ω RF connectors, provided at the two RF ports 34, 35. In other embodiments, the RF connectors may be dispensed with, and the cavity filter 3 can be soldered on the radio board or the antenna board directly by a solder pad. Further, an isolation wall 26 is provided between the resonator 23A and the resonator 23D. The isolation wall 26 is connected to the chassis 21.

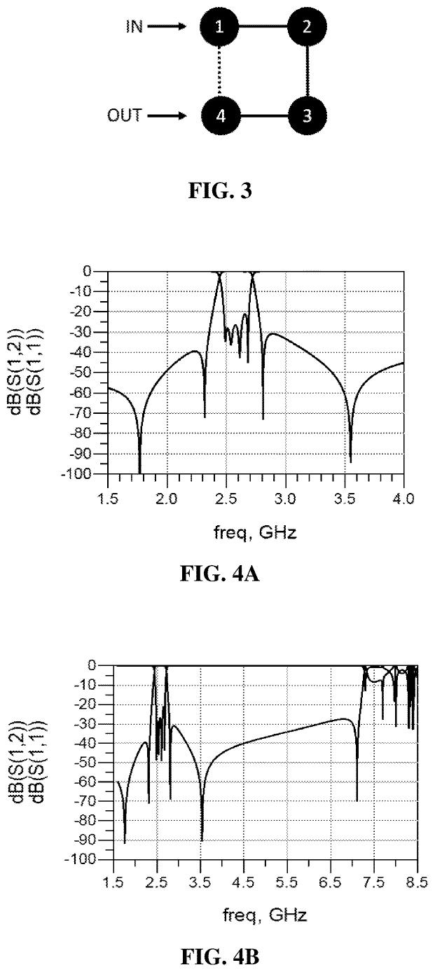

FIG. 3 is a schematic diagram illustrating a topology of the cavity filter 2 shown in FIG. 2A and FIG. 2B. The numbers 1-4 in circle correspond to the resonators 23A-23D, respectively. As can be seen from FIG. 2D and FIG. 3, a negative coupling is realized between two adjacent resonators 23A and 23D by setting a small gap between two adjacent metalized areas 221A and 221D. An inductive coupling is realized between two adjacent resonators 23A and 23B, between two adjacent resonators 23B and 23C, and between two adjacent resonators 23C and 23D, by setting a large gap between two adjacent metalized areas 221A and 221B, between two adjacent metalized areas 221B and 221C, and between two adjacent metalized areas 221C and 221D, respectively. The coupling value between adjacent two of the resonators 23A-23D can be easily tuned by removing a part of the metalized layer of the corresponding coupling tuning blind holes 223A-223D.

FIG. 4A and FIG. 4B each show a simulation frequency response curve of the cavity filter 2 according to the second embodiment, wherein FIG. 4A illustrates in-band performance, and FIG. 4B illustrates out-of-band performance. The second resonant frequency is about triple of the main resonant frequency. Thus, the harmonic performance of the cavity filter 2 is similar as a metal filter and is better than a CWG filter. Moreover, the cavity filter 2 has good Q value and insertion loss compared with same size metal filter.

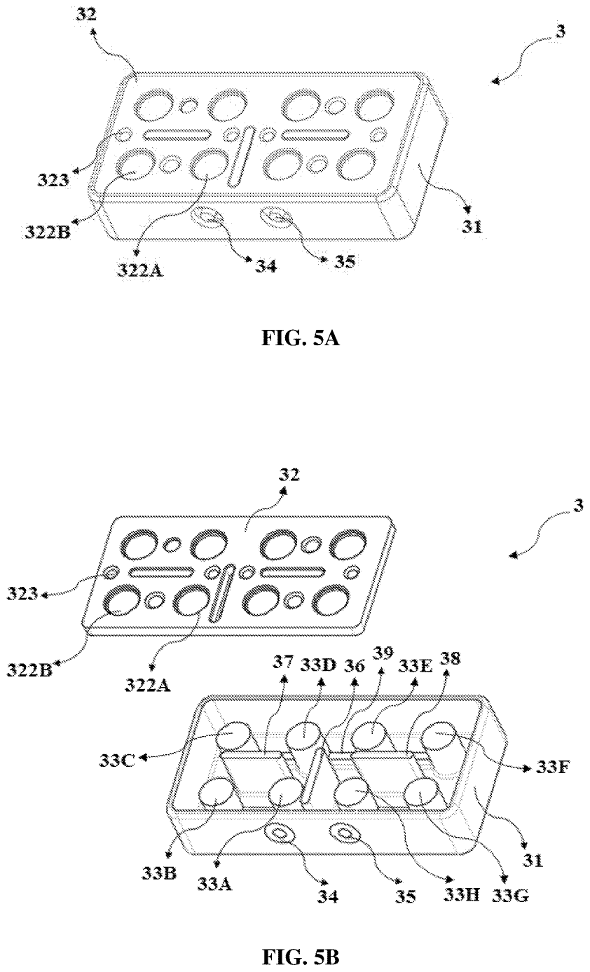

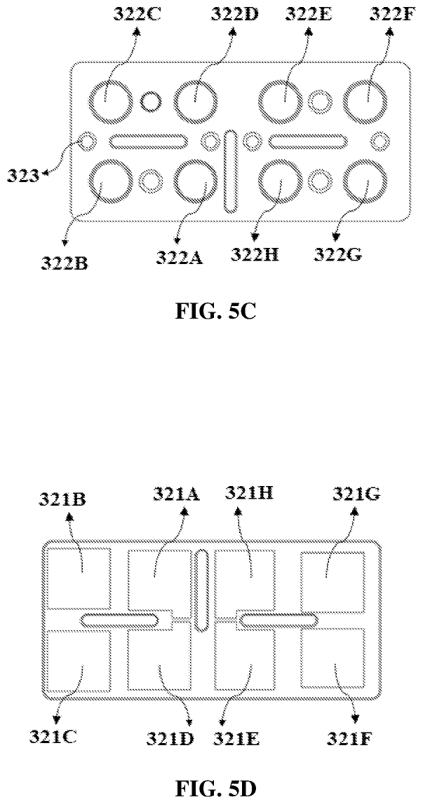

FIG. 5A and FIG. 5B show a cavity filter 3 according to a third embodiment of the disclosure, wherein FIG. 5A illustrates an assembled status of the cavity filter 3, and FIG. 5B illustrates an exploded view of the cavity filter 3. FIG. 5C and FIG. 5D respectively show a top view and a bottom view of a cover plate of the cavity filter 3.

The cavity filter 3 shown in FIG. 5A generally has the shape of a parallelepipedon, and includes a chassis 31 and a cover plate 32. The chassis 31 defines a cavity having a top opening. The cover plate 32 covers the top opening of the cavity. The cover plate 32 is joined to the chassis 31, for example, by soldering or screwing. As shown in FIG. 5A and FIG. 5B, a side surface of the cover plate 32 is joined to an inner surface of the chassis 31. Alternatively, a bottom surface of the cover plate 32 may be joined to an upper edge of the chassis 31. The cavity filter 3 further includes eight resonators 33A-33H disposed in the cavity.

The chassis 31 may be made of metal or a non-metal base with a metallized surface. For the case of a non-metal base with a metallized surface, at least the inner surface of the chassis 31 is entirely metallized, and the outer surface of the chassis 31 may be or may not be metalized. The resonators 33A-33H may also be made of metal or a non-metal base with a metallized surface. The resonators 33A-33H may be integrally formed with the chassis 31. Alternatively, the resonators 33A-33H may be separately formed with and soldered to the chassis 31. The material of the resonators 33A-33H may be the same as or different from the material of the chassis 31.

The cover plate 32 is substantially made of a dielectric material. For example, the dielectric material may be ceramic or plastic. A dielectric constant of the dielectric material is associated with a desired frequency of the cavity filter 3. The dielectric material may have a uniform dielectric constant throughout the cover plate 32. Alternatively, the dielectric material may have different dielectric constants at different regions of the cover plate 32; for example, a first dielectric constant of the dielectric material at a first region near the resonators 33A-33H may be larger than a second dielectric constant of the dielectric material at a second region remote from the resonators 33A-33H.

In this embodiment, a top surface and a side surface of the cover plate 32 are substantially entirely metalized. On the other hand, a bottom surface of the cover plate 32 is only partially metalized. More specifically, the cover plate 32 is provided with eight metalized areas 321A-321H at regions corresponding to the resonators 33A-33H.

The metalized areas 321A-321H may be provided by any known methods. For example, the metalized areas 321A-321H may be formed by plating or printing on the bottom surface of the cover plate 32. Alternatively, the bottom surface of the cover plate 32 may be initially entirely metalized to form a metalized layer like the top surface and the side surface of the cover plate 32, and then a part of the metalized layer on the bottom surface of the cover plate 32 may be removed by applying laser, for example, to form the metalized areas 321A-321H. A size of each of the metalized areas 321A-321H is associated with the desired frequency of the cavity filter 3.

In this embodiment, eight frequency tuning blind holes 322A-322H are provided on the top surface of the cover plate 32 at positions corresponding to the resonators 33A-33H. Each of the frequency tuning blind holes 322A-322H may have a circular cross section as shown, or may be in the shape of a rectangle, an ellipse, or any other appropriate shapes in the cross section. The depth and the area of the frequency tuning blind holes 322A-322H is associated with the desired frequency of the cavity filter 3. The bottom surface and the wall surface of the frequency tuning blind holes 322A-322H are initially entirely metalized, and then a part of the metalized layer of the frequency tuning blind holes 322A-322H may be removed by applying laser, for example, to tune the frequency of the corresponding one of the resonators 33A-33H.

In this embodiment, a capacitance coupling or an inductive coupling between two adjacent resonators 33A-33H may be achieved by setting a gap between two metalized areas 321A-321H on the bottom surface of the cover plate 32 that correspond to the two adjacent resonators 33A-33H. More specifically, a capacitance coupling can be achieved when the distance between two adjacent metalized areas 321A-321H is small. As the distance between two adjacent metalized areas 321A-321H becomes larger, the coupling between two corresponding resonators 33A-33H may change to an inductive coupling.

Further, eight coupling tuning blind holes 323 are provided on the top surface of the cover plate 32 at positions corresponding to the gaps between the adjacent metalized areas 321A-321H. Each of the coupling tuning blind holes 323 may have a circular cross section as shown, or may be in the shape of a rectangle, an ellipse, or any other appropriate shapes in the cross section. The depth and the area of the coupling tuning blind holes 323 is associated with the coupling of the corresponding adjacent resonators 33A-33H. The bottom surface and the wall surface of the coupling tuning blind holes 323 are initially entirely metalized, and then a part of the metalized layer of the coupling tuning blind holes 323 may be removed by applying laser, for example, to tune the coupling of the adjacent resonators 33A-33H.

As shown in FIG. 5A and FIG. 5B, the cavity filter 3 is provided with two RF ports 34, 35 on the same side of the chassis 31. The resonator 33A is connected to a first RF port 34, and the resonator 33H is connected to a second RF port 35. The location of the two RF ports 34, 35 can be adjusted according to actual requirements. For example, the two RF ports 34, 35 may be provided on two different sides of the chassis 31, or the two RF ports 34, 35 may be provided on the bottom of the chassis 31. The cavity filter 3 may be connected to a radio board or an antenna board through RF connectors, such as 50Ω RF connectors, provided at the two RF ports 34, 35. In other embodiments, the RF connectors may be dispensed with, and the cavity filter 3 can be soldered on the radio board or the antenna board directly by a solder pad.

In this embodiment, an isolation wall 36 is provided between the resonator 33A and the resonator 33H, another isolation wall 37 is provided between the resonators 33A, 33B and the resonators 33C, 33D, and a still another isolation wall 38 is provided between the resonators 33E, 33F and the resonators 33G, 33H. Further, as shown in FIG. 5B, coupling bridges 39 are provided between adjacent two of the resonators 33C-33F. It should be understood that the coupling bridges 39 may also be provided between adjacent two of the resonators 33A-33C and/or between adjacent two of the resonators 33F-33H. The isolation walls 36-38 and the coupling bridges 39 are connected to the chassis 31.

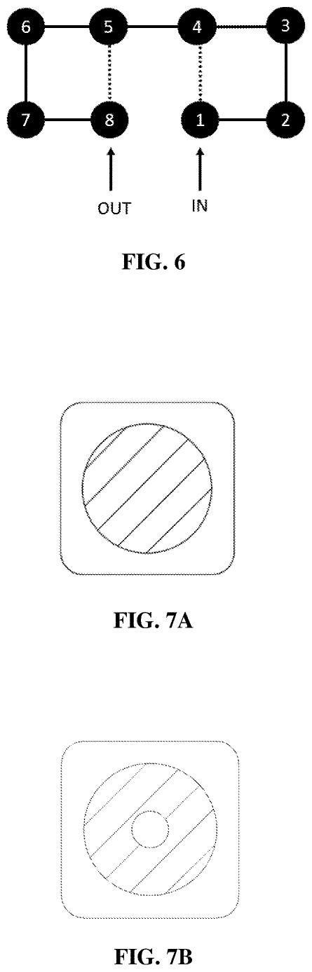

FIG. 6 is a schematic diagram illustrating a topology of the cavity filter 3 shown in FIG. 5A and FIG. 5B. The numbers 1-8 in circle correspond to the resonators 33A-33H, respectively. As can be seen from FIG. 5D and FIG. 6, a first negative coupling is realized between two adjacent resonators 33A and 33D by setting a small gap between two adjacent metalized areas 321A and 321D, and a second negative coupling is realized between two adjacent resonators 33E and 33H by setting a small gap between two adjacent metalized areas 321E and 321H. An inductive coupling is realized between two adjacent resonators 33A and 33B, between two adjacent resonators 33B and 33C, between two adjacent resonators 33C and 33D, between two adjacent resonators 33D and 33E, between two adjacent resonators 33E and 33F, between two adjacent resonators 33F and 33G, and between two adjacent resonators 33G and 33H, by setting a large gap between corresponding adjacent two of the metalized areas 321A-321H, respectively. There is no coupling between the resonator 33A and the resonator 33H. The coupling value between adjacent two of the resonators 33A-33H can be easily tuned by removing a part of the metalized layer of the corresponding coupling tuning blind holes 323.

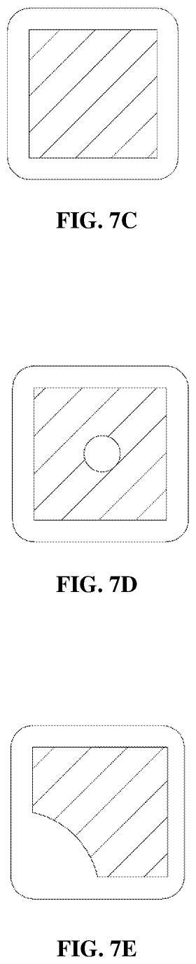

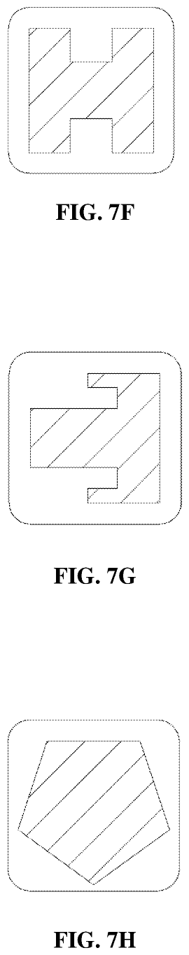

FIGS. 7A-7H show different variants of a metalized area in a bottom surface of a cover plate of a cavity filter according to an embodiment of the disclosure. As described above, the size of the metalized area is associated with the desired frequency of the cavity filter. There is no limitation on the shape of the metalized area. For example, the metalized area may have the shape of a circle (FIG. 7A), an annulus or a circle with a hole (FIG. 7B), a rectangle or square (FIG. 7C), a rectangle or square with a hole (FIG. 7D), a rectangle or square with a corner removed (FIG. 7E), the letter “H” (FIG. 7F), substantially the letter “E” (FIG. 7G), a pentagon (FIG. 7H), and so on.

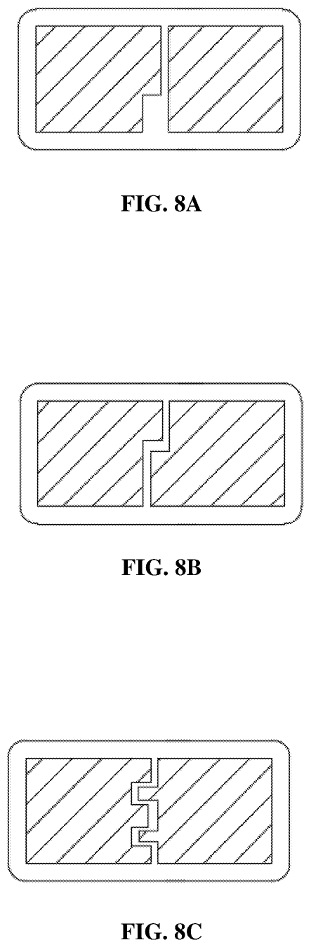

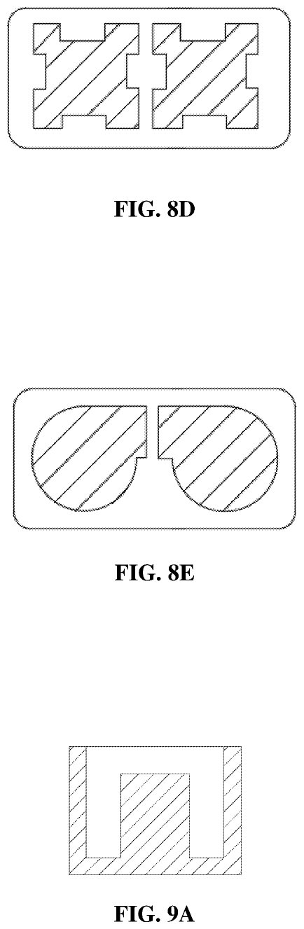

FIGS. 8A-8E show different variants of a negative coupling structure in a bottom surface of a cover plate of a cavity filter according to an embodiment of the disclosure. As described above, a negative coupling between two adjacent resonators can be realized by setting a small gap between two adjacent metalized areas corresponding to the two adjacent resonators. There is no limitation on the shape of the gap or the two adjacent metalized areas, and FIG. 8A-8E merely illustrate several non-limiting examples.

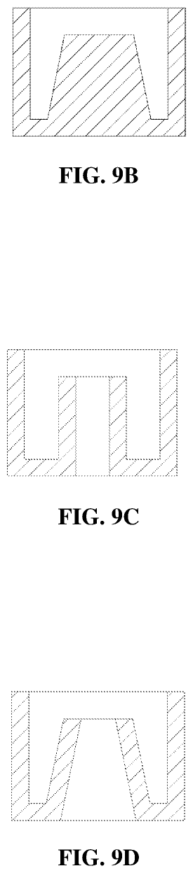

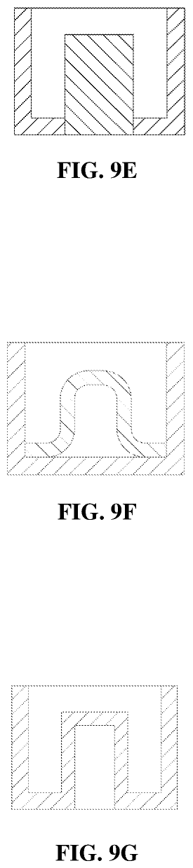

FIGS. 9A-9G show different variants of a resonator in a cavity filter according to an embodiment of the disclosure. As described above, the resonator may be integrally formed with the chassis (FIGS. 9A-9D and 9G), or may be separately formed with and soldered to the chassis (FIG. 9E and FIG. 9F). There is no limitation on the shape of the resonator. For example, the resonator may be cylindrical (FIG. 9A and FIG. 9E), may have a trapezoid longitudinal section (FIG. 9B), or may be bent into an irregular shape (FIG. 9F). As compared with the resonator shown in FIG. 9A or 9B, the resonator shown in FIG. 9C or FIG. 9D is hollow, and the top end of such a resonator is soldered with the metalized area on the bottom surface of the cover plate. The resonator shown in FIG. 9G is formed by stamping or deep drawing a sheet material that forms the chassis.

The present disclosure also relates to a communication device comprising at least one cavity filter as described above, such as an RU or an AU, especially an AAS. In the communication device, the cavity filter may be soldered on a radio board or an antenna board, or may be connected to the radio board or the antenna board by an RF connector.

According to the present disclosure, the cover plate of the cavity filter is substantially made of a dielectric material, and a bottom surface of the cover plate is provided with a metalized area at a region corresponding to the resonator disposed in the cavity. Therefore, the cavity filter has good Q value and low insertion loss as compared with same size metal filters. On the other hand, the cavity filter has good harmonic performance, which is similar as metal filters and much better than CWG filters. Moreover, the cavity filter can be easily tuned at the top side of the cover plate, and no tuning screw is needed, so that the filter size can be reduced and automatic tuning can be achieved. Furthermore, by changing the dielectric constant of the dielectric material of the top plate, the cavity filter can have the same size for different frequency bands, which facilitates packaging of the cavity filter.

In the above embodiments of the present disclosure, the plastic material as the dielectric material may be selected from the group consisting of PE (Polyethylene), PP (Polypropylene), PVC (Polyvinyl Chloride), PET (Polyethylene Terephthalate), PS (Polystyrene), PA (Polyamide), PPS (Polyphenylenesulfide), PC (Polycarbonates) or PI (Polyimide Film). For example, the plastic material can be in the form of LCP (liquid crystal polymer). The metal material for the metallization process can be selected from the group consisting of silver, copper, aluminum, gold, iron, manganese, titanium, chromium or the like.

In the description of the present disclosure, it should be understood that the orientation or position relationship indicated by the terms “upper”, “lower”, “top”, “bottom”, and so on is based on the orientation or position relationship when the filter is placed in a position as shown, for example, in FIG. 1A, only for the convenience of describing the invention and simplifying the description, rather than indicating or implying that the filter or element must have a specific orientation, or must be constructed and operated in a specific orientation. The terms “inner” and “outer” refer to the sides of the chassis with respect to the interior of the filter. All these terms should not be interpreted as limitative for the inventions revealed in the present disclosure.

For all kinds of the cavity filters of the present disclosure, the metallization process involved is not limited to plating or printing. For example, hot stamping, coating, adhesive or the like can be used as well.

References in the present disclosure to “an embodiment”, “another embodiment” and so on, indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

It should be understood that, although the terms “first”, “second” and so on may be used herein to describe various elements, these elements should not be limited by these terms. These terms are only used to distinguish one element from another. For example, a first element could be termed a second element, and similarly, a second element could be termed a first element, without departing from the scope of the disclosure. As used herein, the term “and/or” includes any and all combinations of one or more of the associated listed terms.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components, but do not preclude the presence or addition of one or more other features, elements, components and/or combinations thereof. The terms “connect”, “connects”, “connecting” and/or “connected” used herein cover the direct and/or indirect connection between two elements.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

1-20. (canceled)

21. A cavity filter, comprising:
a chassis that defines a cavity having a top opening;
at least one resonator disposed in the cavity; and
a cover plate that covers the top opening of the cavity, wherein the cover plate is made of a dielectric material, and a bottom surface of the cover plate is provided with a metalized area at a region corresponding to the resonator.

22. The cavity filter according to claim 21, wherein the metalized area is formed by plating or printing on the bottom surface of the cover plate.

23. The cavity filter according to claim 21, wherein the metalized area is formed by removing a part of a metalized layer on the bottom surface of the cover plate.

24. The cavity filter according to claim 21, wherein a dielectric constant of the dielectric material and/or a size of the metalized area is associated with a desired frequency of the cavity filter.

25. The cavity filter according to claim 21, wherein the dielectric material has a uniform dielectric constant throughout the cover plate.

26. The cavity filter according to claim 21, wherein the dielectric material has different dielectric constants at different regions of the cover plate.

27. The cavity filter according to claim 26, wherein a first dielectric constant of the dielectric material at a first region near the resonator is larger than a second dielectric constant of the dielectric material at a second region remote from the resonator.

28. The cavity filter according to claim 21, wherein a top surface and a side surface of the cover plate are substantially entirely metalized.

29. The cavity filter according to claim 28, wherein a frequency tuning blind hole is provided on the top surface of the cover plate at a position corresponding to the resonator.

30. The cavity filter according to claim 21, wherein two or more resonators are disposed in the cavity, and a capacitance coupling or an inductive coupling between two adjacent resonators is achieved by setting a gap between two metalized areas on the bottom surface of the cover plate that correspond to the two adjacent resonators.

31. The cavity filter according to claim 30, wherein a coupling tuning blind hole is provided on the top surface of the cover plate at a position corresponding to the gap.

32. The cavity filter according to claim 21, wherein the dielectric material is ceramic or plastic.

33. The cavity filter according to claim 21, wherein the chassis is made of metal or a non-metal base with a metallized surface.

34. The cavity filter according to claim 21, wherein the resonator is made of metal or a non-metal base with a metallized surface.

35. The cavity filter according to claim 21, wherein the at least one resonator is integrally formed with the chassis.

36. The cavity filter according to claim 21, wherein the at least one resonator is separately formed with and soldered to the chassis.

37. The cavity filter according to claim 21, wherein the cover plate is joined to the chassis by soldering or screwing.

38. A communication device, comprising at least one cavity filter according to claim 21.

39. The communication device according to claim 38, wherein the cavity filter is soldered on a radio board or an antenna board, or is connected to the radio board or the antenna board by an RF connector.

40. The communication device according to claim 38, wherein the communication device is an advanced antenna system.
